(19) United States
(12) Patent Application Publication
(10) Pub. No.: US 2007/0027282 A1
(43) Pub. Date: Feb. 1, 2007

(54) Production of colourless, transparent or opaque coloured plexiglas blocks from a prepolymer that is devoid of residual initiators by thermal polymerisation

(75) Inventors: Klaus Kabs, Pfungstadt (DE); Frank Schaefer, Gross-Gerau (DE); Karl-Heinz Jakob, Schaafheim (DE); Bernd Klossek, Darmstadt (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Roehm GBMH & Co. KG, Darmstadt (DE)

(21) Appl. No.: 10/576,146

(22) PCT Filed: Sep. 15, 2004
(86) PCT No.: PCT/EP04/10301

§ 371 Date: Apr. 18, 2006

(30) Foreign Application Priority Data
Oct. 22, 2003 (DE) 10349544.4

(51) Int. Cl. C08F 118/02

(52) U.S. Cl. 526/319

(57) ABSTRACT

The invention relates to a method for producing polymethyl methacrylate (PMMA) blocks with thicknesses greater than or equal to 200 mm.

### FIELD OF THE ART

The invention relates to a novel casting polymerization process with which it is possible to produce polymethacrylate blocks with a thickness of 200 mm and thicker.

### STATE OF THE ART

U.S. Pat. No. 1,942,531 discloses a process for polymerizing vinyl chloride or styrene in a tubular reactor. The polymerization is carried out in the presence of approx. 1% terpene-like substances.

DE 0 632 951 (Dr. Otto Röhm) discloses a process for polymerizing acrylic esters in the presence of compounds from the terpene series (up to approx. 1%) to give blister-free products.

It is possible with the process to produce nonsplinter glass by polymerization of a monomer mixture between glass sheets.

Munzer et al. (Angewandte Makromolekulare Chemie 11 (1970) p. 27-40) describe the influence of carbocyclic six-membered ring compounds with two nonconjugated double bonds on the suppression of the Trommsdorff effect.

Terpinolene copolymerizes with MMA and thus leads to the reduction in the Trommsdorff effect.

DE 29 41 959 discloses a process for the free-radical polymerization of methyl methacrylate by first preparing a prepolymer and then destroying the initiator in the prepolymer with the aid of a polymerization inhibitor, for example thioether. With the aid of the syrup, sheets up to thickness 20 mm are produced.

Sheets of PLEXIGLAS® are known and are sold commercially by Röhm GmbH & Co. KG. The thickness of the sheets is between 1 mm and 20 mm.

When thicker sheets are required for special applications, for example aquarium construction, these thicker sheets have to be produced by adhesive-bonding of thinner sheets. This constitutes a not inconsiderable level of cost and inconvenience. Owing to the thermal problems in the polymerization, thicker sheets can be produced only with great difficulty. The heat removal entails long polymerization times.

However, even the production of sheets from PLEXIGLAS® with thicknesses customary to date is afflicted with disadvantages.

The thermal polymerization in a combination of water bath and air polymerization cabinet is complicated.

The necessary reaction time is extremely long. In the case of 100 mm-thick blocks, 30 days at 27° C. are required.

### OBJECT

It is thus an object of the invention to develop a polymerization process and to find formulations which allow the production of blocks from PLEXIGLAS® with a thickness between 30 and approx. 500 mm by an economically viable process. The length and width of the blocks is approx. 6000 mm (length) and approx. 3000 mm (width).

Solution

It has now been found that use of a residual initiator-free syrup of partly polymerized methyl methacrylate of the following composition
a) from 10 to 40% by mass of methyl methacrylate
b) from 0.0 to 1.0% by mass of a crosslinker
c) from 0.001 to 0.1% by mass of further compound copolymerizable with the compounds a)-b) (carbocyclic compound)
d) the customary release agents in from 0.01 to 1% by mass
e) 90-60% by mass of a syrup
f) peroxydicarbonates as an initiator for syrup preparation
   allows, in the thermal polymerization process, the production of thick blocks (a thick block is a block with thickness more than 29 mm) in hitherto unknown qualities, yields and polymerization times.

Useful crosslinkers include the following compounds: glycol dimethacrylate, allyl methacrylate, TAC (triallyl cyanurate).

Useful copolymerizable compounds include terpenes and dimeric α-methylstyrene.

The syrup used has to be initiator-free. Initiator-free is understood to mean that the initiators used to prepare the syrup, on attainment of the desired degree of polymerization, are decomposed thermally (>90° C.) so that they are no longer capable of initiating polymerization.

The initiators used are preferably peroxydicarbonates, preferably bis(4-tert-butylcyclohexyl)peroxydicarbonate.

The prepolymerized syrup consists of an MMA polymer dissolved in the monomer and its viscosity is adjusted such that it can be handled in the customary plants, for example to from 1200 mPa·s to 50 mPa·s.

The inventive mixture also comprises polymerization-regulating carbocyclic compounds having at least one double bond, for example terpenes, e.g. γ-terpinene, or dimeric styrene compounds such as dimeric α-methyl-styrene.

The amount of carbocyclic compounds having at least one double bond is between 50 ppm and 300 ppm based on the total amount of the polymerization batch, preferably between 80 ppm and 250 ppm and most preferably between 100 ppm and 200 ppm. “Residual initiator-free” is understood to mean that the amount of the initiators used for the syrup polymerization is below 0.001%. The amount of carbocyclic compound is approx. 100 ppm for sheets with a thickness of 30 mm, 140 ppm for sheets with a thickness of 100 mm and 250 ppm for sheets of 200 mm.

The amount of residual initiator is determined to be <5 ppm. The term “residual initiator-free” relates to the initiators used for the polymerization. In the polymerization, a side reaction forms methyl methacrylate peroxide (MMA peroxide). This MMA peroxide decomposes at high temperature (half-life>100° C.) and does not disrupt the subsequent polymerization at from approx. 25° C. to 40° C.

### EXAMPLES

Preparation of a Residual Initiator-Free Syrup by Feed Polymerization

760 l of MMA are required per batch. For polymerization, 0.08% of a peroxydicarbonate, preferably bis(4-tert-butylcyclohexyl)peroxydicarbonate, is added. After good mixing, half of the solution is initially charged in the heating vessel. The second half remains in the feed vessel. The heating operation is started in automatic operation. The solution is heated to 73° C. After the heating phase has ended, the temperature rises to 86° C. At this temperature, the feed of the second half of methyl methacrylate from the feed vessel begins automatically between 18 and 30 l/min. The temperature should not exceed 93° C. After the feed has ended, the contents are discharged into the cooling vessel. Depending on the cooling conditions, the polymer fraction is 10-30%. The viscosity measured in 6 mm Ford cups is 30-60 seconds. The viscosity is determined analogously to DIN 53211.

Production of a 100 mm Block

By a known process, the solution to be polymerized is poured between two glass sheets which are distanced with a plastic cord. The solution consists of 60-90% residual initiator-free syrup, 10-40% MMA and also the customary additives: the initiator, thermal and UV stabilizer, γ-terpinene (140 ppm) and a release agent. The polymerization is effected at 27° C. After about 12 days, the end polymerization is effected in a heating oven. Without syrup, i.e. with MMA alone, the polymerization time in a waterbath is about 30 days. The time in the heating oven remains unchanged.

What is claimed is:

1. A process for producing plastics moldings with a thickness of 30-200 mm by thermal polymerization of a mixture of a residual initiator-free polymethyl (meth)acrylate syrup and a mixture consisting of MMA and the customary additives and an olefinic carbocyclic compound.

2. The process as claimed in claim 1,
characterized in that
the residual initiator-free polymethyl (meth)acrylate syrup has the following properties:
content of initiator peroxides used: below the detection limit (<5 ppm)
average molecular weight M_{w} 240 000-350 000
composition: from 70 to 90% by mass of methyl methacrylate, from 10 to 30% by mass of PMMA
viscosity: 30-60 seconds (Ford cup).

3. A process for preparing a residual initiator-free polymethyl (meth)acrylate syrup,
characterized in that
a mixture of:
100 parts of MMA and
0.05-0.1 part of peroxydicarbonate
is incipiently polymerized up to conversion of 10-30%.

4. Sheets of PMMA obtainable by a process of claim 1.

5. The use of the sheets of PMMA as claimed in claim 4 for producing aquaria.

6. The process as claimed in claim 1,
characterized in that
the carbocyclic compound is used in amounts of 50-300 ppm based on the amount of the polymerization batch.

7. The process as claimed in claim 1,
characterized in that
the carbocyclic compounds used are terpenes.

8. The process as claimed in claim 1,
characterized in that
the terpene used is γ-terpinene.
